(19) United States
(12) Patent Application Publication
(10) Pub. No.: US 2022/0019926 A1
(43) Pub. Date: Jan. 20, 2022

(54) APPARATUS AND METHOD FOR FUZZING FIRMWARE

(71) Applicant: INDUSTRY ACADEMY COOPERATION FOUNDATION OF SEJONG UNIVERSITY, Seoul (KR)

(72) Inventors: Joo Beom YUN, Seoul (KR); Hyun Wook KIM, Seoul (KR); Ju Hwan KIM, Seoul (KR)

(21) Appl. No.: 17/308,316

(22) Filed: May 5, 2021

(30) Foreign Application Priority Data
Jul. 20, 2020 (KR) 10-2020-0089416

(51) Int. Cl. G06N 7/02; G06N 7/06; G06F 11/36; G06F 9/455

(52) U.S. Cl. CPC G06N 7/023; G06N 7/06; G06F 9/45504; G06F 11/3688; G06F 11/3684; G06N 7/026

(57) ABSTRACT

An apparatus for fuzzing firmware according to an embodiment includes an emulator that provides a user mode emulation environment for firmware installed in any Internet of Things (IoT) device, a generator that generates one or more test cases in which at least some of a plurality of pre-set mutation operators are applied to at least one of a plurality of seed files, and an executor that executes mutation-based fuzzing on the firmware in the user mode emulation environment based on the one or more test cases.

### CROSS-REFERENCE TO RELATED APPLICATION(S)

This application claims the benefit under 35 USC § 119(a) of Korean Patent Application No. 10-2020-0089416, filed on Jul. 20, 2020, in the Korean Intellectual Property Office, the entire disclosure of which is incorporated herein by reference for all purposes.

### BACKGROUND

### 1. Field

The embodiments relate to a technique for executing fuzzing on firmware.

### 2. Description of Related Art

As various devices based on the Internet of Things (IoT) are widely used, firmware installed in each device is also evolving. At the same time, the need to identify and analyze is potential security vulnerabilities inside firmware is also increasing in order to protect users' information.

As there are limitations in manpower and time to analyze these security vulnerabilities individually, studies have been conventionally conducted to detect security vulnerabilities by executing automatic fuzzing after emulating firmware.

However, with the conventional fuzzing method, it is difficult to achieve the effect of improving the speed of fuzzing and the effect of improving compatibility for various IoT devices at the same time, and there is also a limitation in that it is not possible to increase the code coverage of the firmware because test cases for fuzzing cannot be efficiently generated.

### SUMMARY

Embodiments of the present disclosure are directed to execute fuzzing on firmware of IoT devices.

According to an embodiment, there is provided an apparatus for fuzzing firmware including an emulator that provides a user mode emulation environment for firmware installed in any Internet of Things (IoT) device, a generator that generates one or more test cases in which at least some of a plurality of pre-set mutation operators are applied to at least one of a plurality of seed files, and an executor that executes mutation-based fuzzing on the firmware in the user mode emulation environment based on the one or more test cases.

The emulator may include a system mode emulator that emulates an entire system related to the firmware in a system mode emulation environment, and a user mode emulator that emulates a part of process of the firmware in the user mode emulation environment based on a memory file corresponding to the part of the process of the firmware.

The generator may apply at least some of the plurality of mutation operators to at least one of the plurality of seed files based on a particle swarm optimization (PSO) algorithm.

The apparatus for fuzzing firmware may further include a controller that controls the mutation-based fuzzing based on at least one of whether or not a system call occurs, whether or not a new path is detected, and whether or not a crash occurs.

The emulator may additionally provide a system mode emulation environment for the firmware, and the controller may temporarily pause the mutation-based fuzzing and resume the mutation-based fuzzing after processing the system call in the system mode emulation environment when the system call occurs during execution of the mutation-based fuzzing.

The controller may store a test case used to execute the mutation-based fuzzing and report information related to the mutation-based fuzzing when the new path is detected or the crash occurs due to the mutation-based fuzzing.

According to another embodiment, there is provided a method for fuzzing firmware including providing a user mode emulation environment for firmware installed in any Internet of Things (IoT) device, generating one or more test cases in which at least some of a plurality of pre-set mutation operators are applied to at least one of a plurality of seed files, and executing mutation-based fuzzing on the firmware in the user mode emulation environment based on the one or more test cases.

The providing may include emulating an entire system related to the firmware in a system mode emulation environment, and emulating a part of process of the firmware in the user mode emulation environment based on a memory file corresponding to the part of the process of the firmware.

In the generating, at least some of the plurality of mutation operators may be applied to at least one of the plurality of seed files based on a particle swarm optimization (PSO) algorithm.

The method for fuzzing firmware may further include controlling the mutation-based fuzzing based on at least one of whether or not a system call occurs, whether or not a new path is detected, and whether or not a crash occurs.

In the providing, a system mode emulation environment may be provided for the firmware, and the controlling may further include temporarily pausing the mutation-based fuzzing when the system call occurs during execution of the mutation-based fuzzing, processing the system call in the system mode emulation environment; and resuming the mutation-based fuzzing after the system call is processed.

In the controlling, a test case used to execute the mutation-based fuzzing and report information related to the mutation-based fuzzing may be stored when the new path is detected or the crash occurs due to the mutation-based fuzzing.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram for illustrating a firmware fuzzing system according to an embodiment.

FIG. 2 is a block diagram for illustrating a firmware fuzzing apparatus according to an embodiment.

FIG. 3 is a block diagram for illustrating an emulator according to an embodiment in detail.

FIG. 4 is a block diagram for illustrating a firmware fuzzing apparatus according to an additional embodiment.

FIG. 5 is a flowchart for illustrating a method for fuzzing firmware according to an embodiment.

FIG. 6 is a flowchart for illustrating step 510 according to an embodiment in detail.

FIG. 7 is a flowchart for illustrating a method for fuzzing firmware according to an additional embodiment.

FIG. 8 is a flowchart for illustrating an example of a method for fuzzing firmware according to an additional embodiment in detail.

FIG. 9 is a flowchart for illustrating another example of the method for fuzzing firmware according to the additional embodiment in detail.

FIG. 10 is a block diagram for illustratively describing a computing environment including a computing device according to an exemplary embodiment.

### DETAILED DESCRIPTION

Hereinafter, a specific embodiment will be described with reference to the drawings. The following detailed description is provided to aid in a comprehensive understanding of the methods, apparatus and/or systems described herein. However, this is only an example, and the disclosed embodiments are not limited thereto.

In describing the embodiments, when it is determined that a detailed description of related known technologies may unnecessarily obscure the subject matter of the disclosed embodiments, a detailed description thereof will be omitted. In addition, terms to be described later are terms defined in consideration of functions in the disclosed embodiments, which may vary according to the intention or custom of users or operators. Therefore, the definition should be made based on the contents throughout this specification. The terms used in the detailed description are only for illustrating embodiments, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, parts or combinations thereof, other than those described.

In the following embodiments, ‘Internet of Things’ (IoT) refers to a technology that connects various objects to the Internet by embedding sensors and communication functions in various things, and ‘IoT device’ refers to hardware that provides services using IoT. ‘IoT device’ includes, for example, a personal computer (PC), a laptop computer, a smartphone, a tablet PC, a smart band, a smart watch, etc. In addition, hardware that satisfies the above definition is interpreted as belonging to the ‘IoT device’.

In addition, ‘firmware’ refers to any software included in hardware or a device capable of reading or modifying the software, and specifically, in the following embodiments, any software installed in the ‘IoT device’ or an apparatus capable of reading or modifying the software.

Meanwhile, in the following embodiments, ‘fuzzing’ is a kind of software testing technique, which means inputting valid, unexpected or random data into a software program. With this, a collision of a software program, a code verification failure, a potential memory leak, etc. can be detected, and furthermore, a security problem with the software program can be found.

Specifically, ‘fuzzing’ is divided into ‘generation-based fuzzing’ and ‘mutation-based fuzzing’ according to the method of generating test cases that are input into the software program when executed. ‘Generation-based fuzzing’ defines a new test case based on a structure of the software program when it is executed, whereas ‘mutation-based fuzzing’ generates the test case by transforming a previously prepared seed file when it is executed.

FIG. 1 is a block diagram for illustrating a firmware fuzzing system 100 according to an embodiment.

As illustrated, the firmware fuzzing system 100 according to an embodiment includes a firmware fuzzing apparatus 110, one or more IoT devices 120, and a plurality of seed files 130. In FIG. 1, an embodiment in which N IoT devices 120 ranging from IoT device #1 to IoT device #N are included is illustrated.

Referring to FIG. 1, the firmware fuzzing apparatus 110 acquires a series of information for analysis of firmware installed in each IoT device from each of IoT devices #1 to #N through a communication network. For example, the firmware fuzzing apparatus 110 may acquire information on the architecture, instruction set, version, and other codes of each firmware from each IoT device, but may additionally acquire information necessary for analysis of firmware.

In some embodiments, the communication network may include the Internet, one or more local area networks, wide area networks, cellular networks, mobile networks, other types of networks, or a combination of these networks.

After that, the firmware fuzzing apparatus 110 emulates the acquired information, and s executes fuzzing for each firmware installed in the IoT device using a test case generated by transforming the plurality of seed files 130 as input.

In the following embodiments, ‘emulating’ means executing a series of processes by implementing another system (emulation environment) obtained by duplicating the original system, and the apparatus that executes ‘emulating’ is referred to as an ‘emulator’. If a test case is input directly into each firmware, the speed at which fuzzing is executed is slow due to the limitation in performance of the processor of the IoT device and it is also not suitable for monitoring when fuzzing is executed, and thus, hereinafter, it is assumed that fuzzing for firmware is executed in an emulated emulation environment.

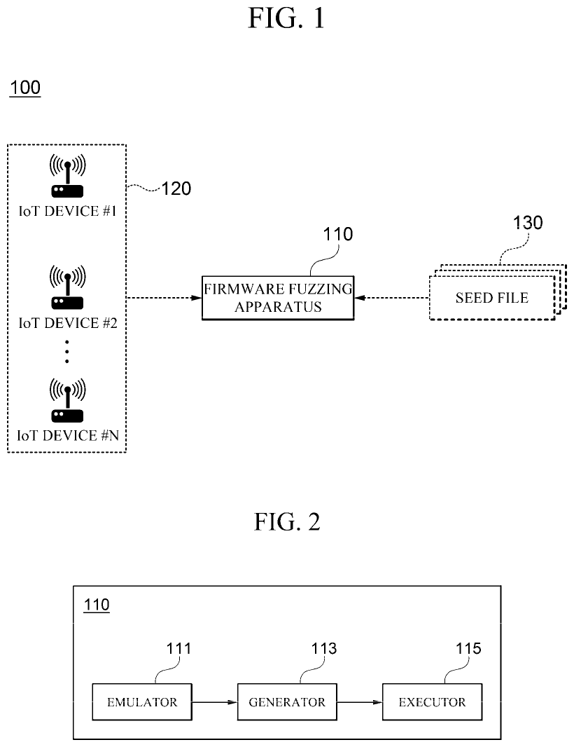

FIG. 2 is a block diagram for illustrating the firmware fuzzing apparatus 110 according is to an embodiment. As illustrated, the firmware fuzzing apparatus 110 according to an embodiment includes an emulator 111, a generator 113, and an executor 115.

The emulator 111 provides a user mode emulation environment for firmware installed in any IoT device.

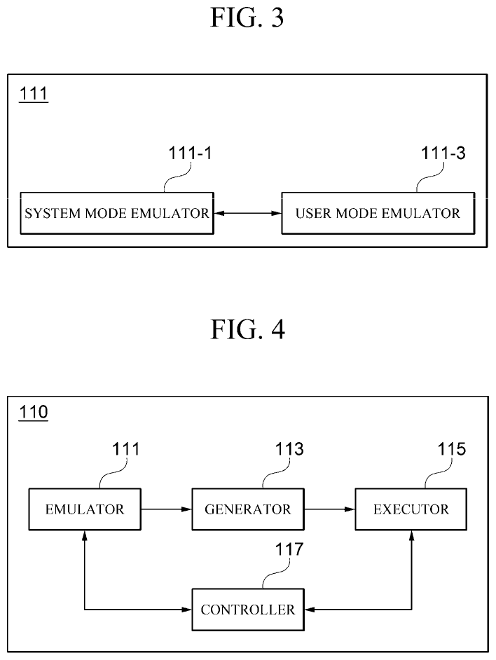

In this regard, FIG. 3 is a block diagram for illustrating the emulator 111 according to an embodiment in detail. Referring to FIG. 3, the emulator 111 according to an embodiment may include a system mode emulator 111-1 and a user mode emulator 111-3.

According to an embodiment, the system mode emulator 111-1 may emulate the entire system related to firmware in a system mode emulation environment.

Specifically, the ‘system mode emulator’ implements an emulation environment for each IoT device as a whole, and this environment is referred to as the ‘system mode emulation environment’.

When fuzzing is executed in the system mode emulation environment, the execution speed of fuzzing is faster than when fuzzing is executed directly to the IoT device, but there is a disadvantage in that the execution speed is halved due to overhead and various calls because the entire process of firmware is processed.

On the other hand, according to an embodiment, the user mode emulator 111-3 may emulate a part of a process of firmware in the user mode emulation environment based on a memory file corresponding to the part of the process of firmware.

Specifically, the ‘user mode emulator’ implements an emulation environment for the part of the process by sharing the memory file corresponding to the part of the process emulated in the system mode emulation environment from the system mode emulator, and this environment is referred to as the ‘user mode emulation environment’.

When fuzzing is executed in the user mode emulation environment, there are fewer overheads and various calls compared to when executing fuzzing in the system mode emulation environment, and thus there is an advantage in that fuzzing can be executed without halving the speed.

Referring back to FIG. 2, the generator 113 generates one or more test cases in which at least some of a plurality of preset mutation operators are applied to at least one of the plurality of seed files 130.

In this case, the plurality of preset mutation operators may include, for example, mutation operators defined in Table 1 below.

TABLE 1

| | Name of | |
|---|---|---|
| Serial | mutation | |
| number | operator | Function |
| 1 | bitflip | Reverse one bit or multiple |
| | | consecutive bits |
| 2 | byteflip | Reverse one byte or multiple |
| | | consecutive bytes |
| 3 | arithmetic | Add or subtract one or more bytes |
| | inc/dec | |
| 4 | interesting | Convert byte of test case into |
| | values | preset byte |
| 5 | user extras | Insert user-supplied value into byte |
| | | of test case or convert byte of test |
| | | case into user-supplied value |
| 6 | random bytes | Convert one byte of test case to |
| | | random byte |
| 7 | delete bytes | Randomly delete multiple |
| | | consecutive bytes |
| 8 | insert bytes | Randomly copy some bytes of test |
| | | case and copy them to another |
| | | location within test case |
| 9 | overwrite | Randomly overwrite multiple |
| | bytes | consecutive bytes in test case |
| 10 | cross over | Create new test case by joining |
| | | parts of two different test cases |

According to an embodiment, the generator 113 may apply at least some of the plurality of disparity operators to at least one of the plurality of seed files based on a particle swarm optimization (PSO) algorithm.

Specifically, the generator 113 may select a mutation operator to be applied to generate a test case from among a plurality of preset mutation operators through the following process.

(1) Set the number of mutation operators to select from among all mutation operators.

(2) By applying the PSO algorithm to each set consisting of the set number of mutation operators, search for the mutation operator with optimal efficiency in each set.

Specifically, this means searching for the most efficient mutation operator among the previously applied mutation operators, not the mutation operator currently applied when fuzzing firmware.

(3) Among the sets, search for the set with optimal efficiency.

(4) In the set with optimal efficiency, select the most efficient mutation operator as the mutation operator to be applied in the next mutation process.

In this case, the efficiency of the mutation operator or the efficiency of the set may be calculated based on the mutation time required when applying each mutation operator, the fuzzing execution time, a newly detected path or crash, etc.

The executor 115 executes mutation-based fuzzing for firmware in the user mode emulation environment based on one or more generated test cases.

FIG. 4 is a block diagram for illustrating the firmware fuzzing apparatus 110 according to an additional embodiment.

As illustrated, the firmware fuzzing apparatus 110 according to the additional embodiment may further include a controller 117. In the example illustrated in FIG. 4, since the generator 113 and the executor 115 have the same configuration as those illustrated in FIG. 1, a redundant description thereof will be omitted.

The controller 117 may control mutation-based fuzzing based on at least one of whether or not a system call (syscall) occurs, whether or not a new path is detected, and whether or not a crash occurs.

According to an embodiment, the emulator 111 may additionally provide a system mode emulation environment for firmware. Meanwhile, when the system call occurs while the mutation-based fuzzing is being executed, the controller 117 may temporarily pause the mutation-based fuzzing and resume the mutation-based fuzzing after processing the system call in the system mode emulation environment.

In the following embodiments, the ‘system call’ refers to a call that cannot be processed on a process executed running in the user mode emulation environment.

Specifically, when the system call occurs while executing mutation-based fuzzing, the controller 117 may store a memory file corresponding to the process currently being executed, and may cause a process corresponding to the transmitted memory file to be processed in a system mode emulation environment.

Subsequently, the controller 117 may store a memory file corresponding to the process in which the system call is processed, and cause the executor 115 to execute mutation-based fuzzing again.

According to an embodiment, when a new path is detected or a crash occurs due to mutation-based fuzzing, the controller 117 may store the test case used to execute mutation-based fuzzing and report information related to mutation-based fuzzing.

In this case, the report information may include information on random values that has occurred in the process of executing mutation-based fuzzing and information on a crash that has occurred as a result of mutation-based fuzzing. Specifically, the controller 117 may store the test case as a new seed file in a seed queue including the plurality of seed files 130, and store the report information in a separate database (not illustrated) or a clipboard. However, it should be noted that the location where the test case or report information is stored is not limited thereto.

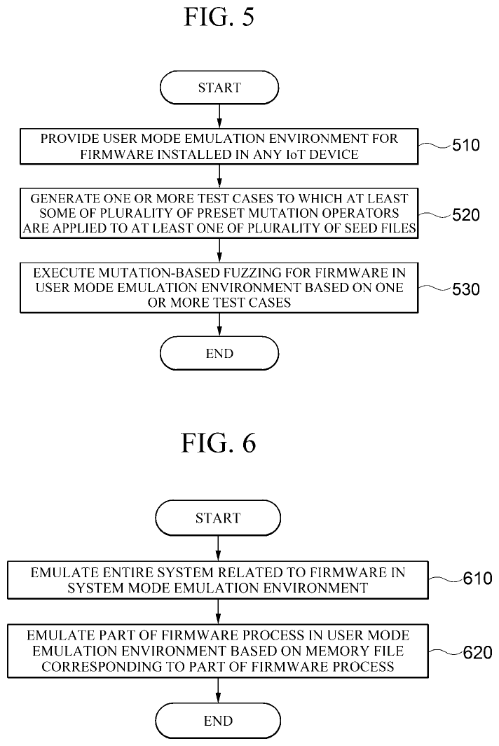

FIG. 5 is a flowchart for illustrating a method for fuzzing firmware according to an embodiment.

The method illustrated in FIG. 5 may be performed by, for example, the firmware fuzzing apparatus 110 described above.

First, the firmware fuzzing apparatus 110 provides a user mode emulation environment for firmware installed in any IoT device (510).

After that, the firmware fuzzing apparatus 110 generates one or more test cases in which at least some of a plurality of preset mutation operators are applied to at least one of the plurality of seed files 130 (520).

After that, the firmware fuzzing apparatus 110 executes mutation-based fuzzing for the firmware in the user mode emulation environment based on one or more test cases (530).

FIG. 6 is a flowchart for illustrating step 510 according to an embodiment in detail. The method illustrated in FIG. 6 may be performed, for example, by the firmware fuzzing apparatus 110 described above.

First, the firmware fuzzing apparatus 110 may emulate the entire system related to the firmware in a system mode emulation environment (610).

After that, the firmware fuzzing apparatus 110 may emulate a part of the firmware process in the user mode emulation environment based on a memory file corresponding to the part of the firmware process (620).

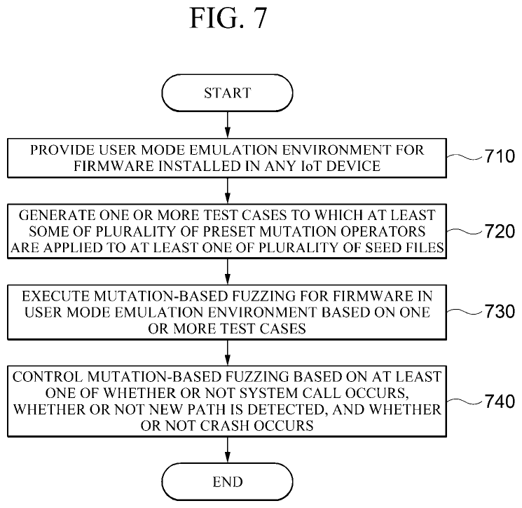

FIG. 7 is a flowchart for illustrating a method for fuzzing firmware according to an is additional embodiment.

The method illustrated in FIG. 7 may be performed, for example, by the firmware fuzzing apparatus 110 described above.

First, the firmware fuzzing apparatus 110 provides the user mode emulation environment for firmware installed in any IoT device (710).

After that, the firmware fuzzing apparatus 110 generates one or more test cases in which at least some of the plurality of preset mutation operators are applied to at least one of the plurality of seed files 130 (720).

After that, the firmware fuzzing apparatus 110 executes mutation-based fuzzing for the firmware in the user mode emulation environment based on one or more test cases (730).

After that, the firmware fuzzing apparatus 110 may control mutation-based fuzzing based on at least one of whether or not a system call occurs, whether or not a new path is detected, and whether or not a crash occurs (740).

In this case, the control of the mutation-based fuzzing by the firmware fuzzing apparatus 110 may be executed in various forms. Hereinafter, a method for fuzzing firmware related thereto will be illustratively described.

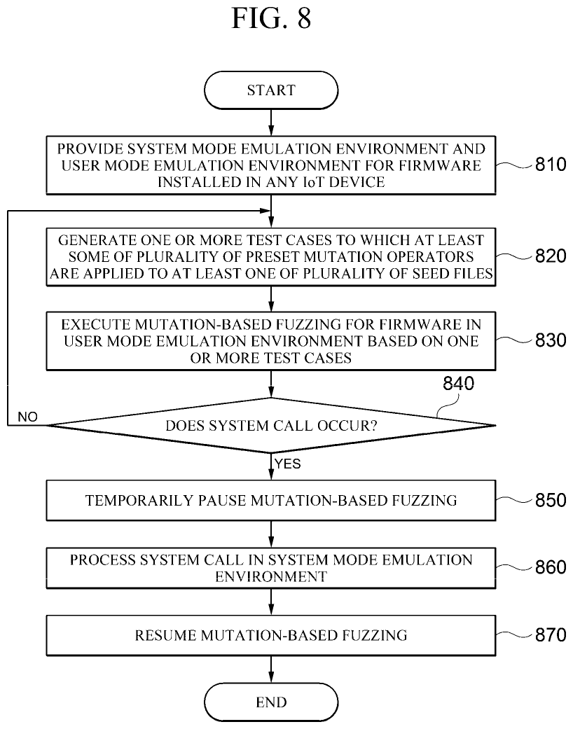

FIG. 8 is a flowchart for illustrating an example of a method for fuzzing firmware according to an additional embodiment in detail.

The method illustrated in FIG. 8 may be performed, for example, by the firmware fuzzing apparatus 110 described above.

First, the firmware fuzzing apparatus 110 may provide the system mode emulation environment and the user mode emulation environment for firmware installed in any IoT device (810).

After that, the firmware fuzzing apparatus 110 generates one or more test cases in which at least some of the plurality of preset mutation operators are applied to at least one of the plurality of seed files 130 (820).

After that, the firmware fuzzing apparatus 110 executes mutation-based fuzzing for the firmware in the user mode emulation environment based on one or more test cases (830).

After that, the firmware fuzzing apparatus 110 may determine whether a system call occurs while executing mutation-based fuzzing (840).

After that, when the system call occurs, the firmware fuzzing apparatus 110 may temporarily pause the mutation-based fuzzing (850).

After that, the firmware fuzzing apparatus 110 may process the system call in the system mode emulation environment (860).

After that, the firmware fuzzing apparatus 110 may resume the temporarily paused mutation-based fuzzing after the system call is processed (870).

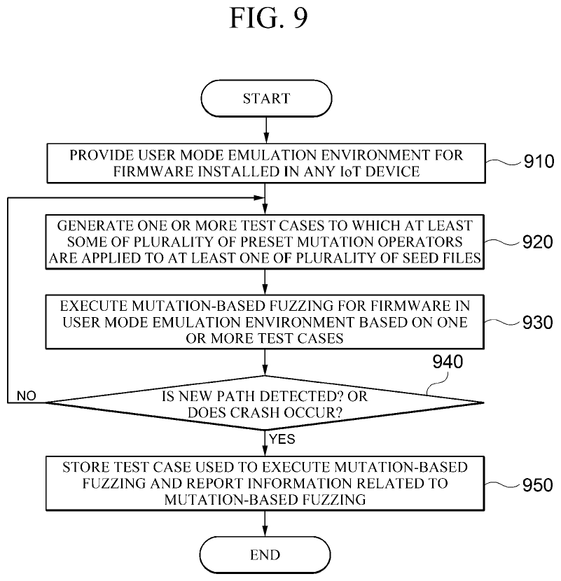

FIG. 9 is a flowchart for illustrating another example of a method for fuzzing firmware according to an additional embodiment in detail.

The method illustrated in FIG. 9 may be performed by, for example, the firmware fuzzing apparatus 110 described above.

First, the firmware fuzzing apparatus 110 provides the user mode emulation environment for firmware installed in any IoT device (910).

After that, the firmware fuzzing apparatus 110 generates one or more test cases in which at least some of a plurality of preset mutation operators are applied to at least one of the plurality of seed files 130 (920).

After that, the firmware fuzzing apparatus 110 executes mutation-based fuzzing for firmware in the user mode emulation environment based on one or more test cases (930).

After that, the firmware fuzzing apparatus 110 may determine whether a new path is detected or a crash occurs due to the mutation-based fuzzing, as a result of the mutation-based fuzzing (940).

After that, when it is determined that the new path is detected or the crash has occurred, the firmware fuzzing apparatus 110 may store the test case used to execute mutation-based fuzzing and report information related to mutation-based fuzzing (950).

In the illustrated FIGS. 5 to 10, the method described above is described by dividing the method into a plurality of steps, but at least some of the steps may be performed in a different order, performed together in combination with other steps, omitted, performed by being divided into sub-steps, or performed by being added with one or more steps (not illustrated).

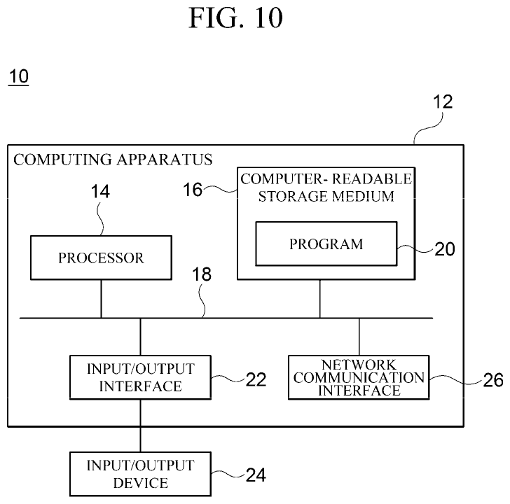

FIG. 10 is a block diagram for illustratively describing a computing environment 10 that includes a computing device according to an embodiment. In the illustrated embodiment, each component may have different functions and capabilities in addition to those described below, and additional components may be included in addition to those described below.

The illustrated computing environment 10 includes a computing device 12. In an embodiment, the computing device 12 may be the firmware fuzzing apparatus 110.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured to cause the computing device 12 to perform operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In one embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a voice or sound input device, input devices such as various types of sensor devices and/or photographing devices, and/or output devices such as a display device, a printer, a speaker, and/or a network card. The exemplary input/output device 24 may be included inside the computing device 12 as a component constituting the computing device 12, or may be connected to the computing device 12 as a separate device distinct from the computing device 12.

Meanwhile, the embodiment of the present invention may include a program for performing the methods described in this specification on a computer, and a computer-readable recording medium containing the program. The computer-readable recording medium may contain program instructions, local data files, local data structures, etc., alone or in combination. The computer-readable recording medium may be specially designed and configured for the present invention, or may be commonly used in the field of computer software. Examples of computer-readable recording media include magnetic media such as a hard disk, a floppy disk, and a magnetic tape, optical recording media such as a CD-ROM and a DVD, and hardware devices such as a ROM, a RAM, a flash memory, etc., that are specially configured to store and execute program instructions are included. Examples of the program may include a high-level language code that can be executed by a computer using an interpreter, etc., as well as a machine language code generated by a compiler.

According to the disclosed embodiments, by executing emulating complexly for firmware in a system mode emulation environment and a user mode emulation environment, it is possible to improve speed and compatibility when fuzzing is executed.

In addition, according to the disclosed embodiments, by appropriately selecting a mutation operator and generating a test case, it is possible to widen code coverage when fuzzing firmware.

Although the present invention has been described in detail through representative examples above, those skilled in the art to which the present invention pertains will understand that various modifications may be made thereto within the limit that do not depart from the scope of the present invention. Therefore, the scope of rights of the present invention should not be limited to the described embodiments, but should be defined not only by claims set forth below but also by equivalents of the claims.

What is claimed is:

1. An apparatus for fuzzing firmware, the apparatus comprising:
an emulator that provides a user mode emulation environment for firmware installed in any Internet of Things (IoT) device;
a generator that generates one or more test cases in which at least some of a plurality of pre-set mutation operators are applied to at least one of a plurality of seed files; and
an executor that executes mutation-based fuzzing on the firmware in the user mode emulation environment based on the one or more test cases.

2. The apparatus of claim 1, wherein the emulator comprises:
a system mode emulator that emulates an entire system related to the firmware in a system mode emulation environment; and
a user mode emulator that emulates a part of process of the firmware in the user mode emulation environment based on a memory file corresponding to the part of the process of the firmware.

3. The apparatus of claim 1, wherein the generator applies at least some of the plurality of mutation operators to at least one of the plurality of seed files based on a particle swarm optimization (PSO) algorithm.

4. The apparatus of claim 1, further comprising:
a controller that controls the mutation-based fuzzing based on at least one of whether or not a system call occurs, whether or not a new path is detected, and whether or not a crash occurs.

5. The apparatus of claim 4, wherein the emulator further provides a system mode emulation environment for the firmware; and
the controller temporarily pauses the mutation-based fuzzing and resume the mutation-based fuzzing after processing the system call in the system mode emulation environment when the system call occurs during execution of the mutation-based fuzzing.

6. The apparatus of claim 4, wherein the controller stores a test case used to execute the mutation-based fuzzing and report information related to the mutation-based fuzzing when the new path is detected or the crash occurs due to the mutation-based fuzzing.

7. A method for fuzzing firmware, the method comprising:
providing a user mode emulation environment for firmware installed in any Internet of Things (IoT) device;
generating one or more test cases in which at least some of a plurality of pre-set mutation operators are applied to at least one of a plurality of seed files; and
executing mutation-based fuzzing on the firmware in the user mode emulation environment based on the one or more test cases.

8. The method of claim 7, wherein the providing comprises:
emulating an entire system related to the firmware in a system mode emulation environment; and
emulating a part of process of the firmware in the user mode emulation environment based on a memory file corresponding to the part of the process of the firmware.

9. The method of claim 7, wherein, in the generating, at least some of the plurality of mutation operators is applied to at least one of the plurality of seed files based on a particle swarm optimization (PSO) algorithm.

10. The method of claim 7, further comprising:
controlling the mutation-based fuzzing based on at least one of whether or not a system call occurs, whether or not a new path is detected, and whether or not a crash occurs.

11. The method of claim 10, wherein, in the providing, a system mode emulation environment is provided for the firmware; and
the controlling further comprises:
temporarily pausing the mutation-based fuzzing when the system call occurs during execution of the mutation-based fuzzing;
processing the system call in the system mode emulation environment; and
resuming the mutation-based fuzzing after the system call is processed.

12. The method of claim 10, wherein, in the controlling, a test case used to execute the mutation-based fuzzing and report information related to the mutation-based fuzzing are stored when the new path is detected or the crash occurs due to the mutation-based fuzzing.
